(19) United States
(12) Patent Application Publication
(10) Pub. No.: US 2009/0189722 A1
(43) Pub. Date: Jul. 30, 2009

(54) Flexible magnet coating

(76) Inventor: Wang Xiaoming, Anaheim, CA (US)

Correspondence Address: WANG XIAOMING, 2831 VIA MARTENS, ANAHEIM, CA, 92806, US

(21) Appl. No.: 12/011,006

(22) Filed: Jan. 24, 2008

(51) Int. Cl. H01F 7/02

(52) U.S. Cl. 335/219

(57) ABSTRACT

This invention provides a direct printable rubber magnet, which includes a rubber magnet layer and a coating layer. The coating layer combines with the surface of rubber magnet layer. This coated rubber magnet is printable, write-able and color paint-able on the coated surface. This invention makes the printable coating layer directly coated on the magnet layer to reach the same function as existing printable flexible magnet which usually have to be laminated with adhesive and PVC or paper on magnet, therefore, the process technique is much more simple, reasonable, easier than previous art, and it is more cost effective also. Moreover, the printable rubber magnet from this invention is quite convenient for recycling, as it does not have the cost caused by the simultaneous recycling of the plastic or the paper and so on. The superficial coating layer on the rubber magnet is very thin and accounts for nothing comparing to the thickness of whole magnet, and it is not necessary to separate the coating layer with magnet layer while recycling. Therefore, this invention makes recycling of magnet to be much simpler, much more inexpensive, and more environmental friendly.

### BACKGROUND

1. Technical Field of the Invention

This invention generally relates to printable flexible magnet, primarily to direct printable flexible magnet for prevention of wasted time and material in the lamination of printable surfaces and secondarily in the recycling of the magnet material.

2. Description of Prior Art

The existing printable rubber magnet is generally formed by a magnet material layer with an inward magnetic face. The magnet material layer is made of a binder with magnetic powder or the iron powder. It is calendared and roll pressed into sheets. Then it is magnetized on the inward face. Then a second layer is commonly an adhesive. Adhesive is applied to the magnet or the laminate face. Then a third layer is commonly the plastic layer (e.g. PVC)—or the paper layer (e.g. high gloss paper). The third layer is laminated to the outward face of the magnet material layer with the adhesive in between. On the outward face of the plastic or paper layer one may print, write, draw artwork. The prior art rubber magnet has varied forms, which may be attracted to the surface of the steel wall or other magnetic surfaces, owning the effect of beautified decoration. Flexible magnet material is typically used for printing signs and marketing promotional items.

However, there are still some obvious shortcomings in the structure of the existing rubber magnet:
(1) In prior art, two layers are added to the magnet layer. The adhesive layer and the laminate layer (plastic or paper). This lamination was required to be thick enough to support it own weight plus the adhesive throughout the transportation and lamination process. The added thickness was not needed for printing, it was wasted on providing structure. The adhesive is costly.
(2) The prior art laminate layer requires a relatively thick structure to support itself and the adhesive during transport and production processing. The added thickness was not needed to create a printable surface, it was wasted on providing structure. The plastic or paper is costly.
(3) Prior art requires specialized labor and relatively more time for operation of the laminating machinery and processing.
(4) Separate expensive machinery is needed for laminating. The laminations were typically applied on a lamination machine with at least 2 pressing rollers, two feeding rollers, methods to align the rollers and expensive stepper motors controls for all rollers.
(5) Prior art could not develop a coating that had the characteristics needed to make a good printable surface and bond to the magnet material. Flexibility, indoor outdoor durability, water resistant, UV resistant, absorbed water different ink/paint types.
(6) It is also troublesome to recycle the rubber magnet when it is no longer used, because the plastic rubber magnet can be recycled only when the layers are separated from each other, however, the cost is high for separating the firmly glued outward layer from the magnet layer, thus this kind of rubber magnet material is not good for recycling to use again. The recycling of magnet material with laminates is more expensive than the cost of reproducing virgin material. The vinyl laminate is not biodegradable and therefore requires special disposal.
(7) The laminate can be configured to accept oil based ink/paint or water based ink/paint, but not both.
(8) The lamination was typically over applied with a “lip”. Then both the lamination and the magnet were cut to form a true edge. The cut off ¼-½″ was wasted.
(9) The separate lamination increases the shipping weight of the product.
(10) The separate lamination increases the weight. The magnetic strength is then wasted to hold up the lamination.

### SUMMARY OF THE INVENTION

This invention provides a direct printable rubber magnet, which includes a rubber magnet layer and a coating layer. The coating layer adheres to the surface of rubber magnet layer. The coating replaces the need for adhesive on laminates. The coating replaces 50-70% of the thickness of the laminate. The coating allows for recycling easily as it does not have the cost caused by the separating laminated layers. The coating itself may be re-used in the magnet. The superficial coating layer on the rubber magnet is very thin and accounts for nothing compared to the thickness of whole magnet, and it is not necessary to separate the coating layer with magnet layer while recycling. This coating decreases the shipping weight. This coating decreases the scrap from the edges of a lamination. This invention makes the printable coating layer reach the same function as existing laminated PVC or paper. The production is much more simple than prior art laminating machines. The coating layer is covered on either one surface or both surfaces of the magnet or the edges. The coating layer could be more than one layer thick. The material of the coating layer is configured to accept either water base or oil base paint and inks or both. The coating layer could be transparent, monochromatic, multicolor or colored. The coating layer is very thin, generally, the weight of the dry film of said coating is between 5-300 g/m2.

### OBJECTS AND ADVANTAGES

Compared with the prior art, my invention has following objects and advantages:
1) Because the coating layer replaces the adhesive and the laminate plastic or paper, it serves two purposes in one. The cost of the adhesive is saved.
2) Because no thick structure is required to support the coating during transport and production processing, one half the thickness of the laminate can be used. One half of the laminate material costs are saved.
3) Because the coating layer is applied as a liquid and squeegeed off, production is easily automated. It requires no specialized labor. Labor time is cut, realizing the lost time of the slower process of laminating plastic or paper.
4) No separate or expensive machinery is needed for laminating. The coating is applied easily as a liquid and squeegee station in the production line. This coating method is already being used to easily apply a protective coating to the magnetic side.
5) The coating will bond to flexible magnet strongly, it is flexible, UV resistant, water resistant, absorbs different kinds of ink/paint.
6) The rubber magnet of my invention is quite convenient for recycling. My invention does not have the cost of separating the laminate from the magnet; which is caused by the simultaneous recycling of magnet with the plastic or the paper. The superficial coating layer on the the rubber magnet accounts for not much to the whole and will be recycled together with the bond magnet. The material of the coating is inert and will not dilute or adversely affect the magnetic strength of the product when reprocessed. Therefore, recycling is much simpler, the relative cost is much less expensive. Environmental protection effect would be increased by 70-90%. It would truly pay to recycle.
7) The material of the coating layer can be configured to accept either water base or oil base paint or print inks. Therefore, two types of laminates are replaced by one coating. A different laminate is not needed for a printer using oil based ink/paint and a different laminate for a printer using water based ink/paint. This greatly reduces warehousing and distribution costs.
8) The liquid coating it squeegeed off the sides and reused. No waste is created by over hanging edges or “lips”.
9) Because the coating layer works also as the adhesive, it serves two purposes in one. The structure is thinner and lighter than laminated flexible magnet. Therefore it is cheaper to ship.
10) Because the coating layer works also as the adhesive, it serves two purposes in one. The structure is thinner and lighter than laminated flexible magnet. It is stronger to hold magnetically. The magnet of my invention is not holding up the weight of a relatively thick laminate. Therefore, it can hold more of what it is intended to hold.

### DRAWING FIGURES

FIG. 1 is a side view of the preferred embodiment of this invention.

FIG. 2 is a side view of an alternate embodiment of this invention.

FIG. 3 is a side view of an alternate embodiment of this invention.

FIG. 4 is a side view of an alternate embodiment of this invention

### REFERENCE NUMERALS IN DRAWINGS

1 Flexible Magnet Material

2 Monochromatic Coating

2-1 Transparent Coating

2-3 Colored Coating

### DETAILED DESCRIPTION OF THE PREFERRED EMBODIMENTS

While the present invention has been further described in connection with the embodiments and the drawings, it is understood that this invention is not limited to the disclosed embodiments.

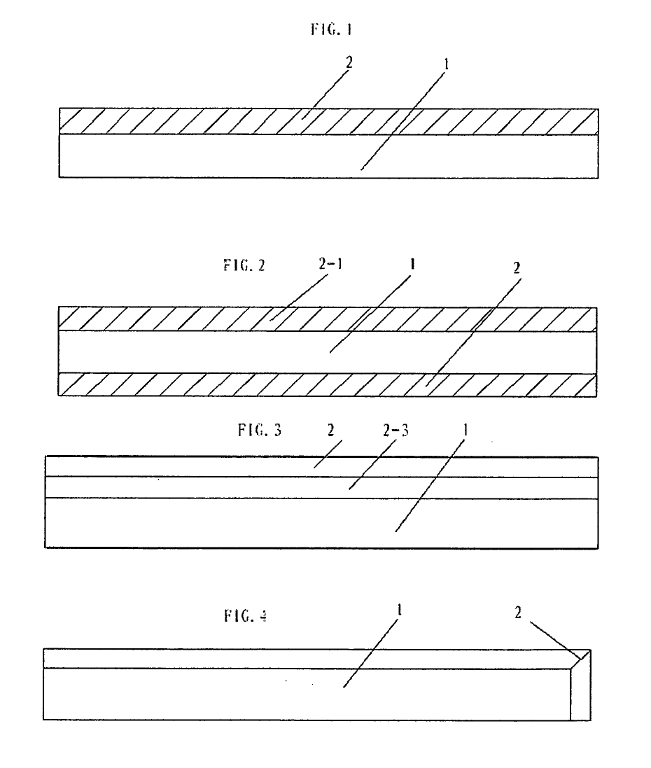

Preferred Embodiment shown in FIG. 1, is a side view of this invention, the rubber magnet including a bond magnet 1, a monochromatic coating layer 2 is on the upper surface of the bond magnet 1, the monochromatic coating layer 2 is chemically adhered to the bond magnet 1; The bond magnet 1 is a mix, which is the binding of the magnet powder with the binding agent. The binding agent could be CPE, PVC, EVA, PE, Nylon, NBR or PP; The material of the coating layer 2 could be printing coating either watery or oil, may form on the surface of the bond magnet 1 through the direct spreading of a liquid and squeegee off; the monochromatic coating layer 2 is thin, generally, the weight of the dry film of the coating layer is between 5-300 g/m2.

Alternate Embodiment shown in FIG. 2, is a side view of this invention. The bond magnet has the following features: coating layers are on the upper surface and the lower surface of the bond magnet 1 simultaneity, a monochromatic coating layer 2 is combined to the upper surface of the bond magnet 1, the material of which is the typing reflex printing coating either watery or oil. A coating layer 2-1 on the lower surface is transparent, the material of which is printing coating either watery or oil. The bond magnet 1 is a mix bound by the binding agent which could be CPE, PVC, EVA, PE, Nylon, NBR or PP.

Alternative Embodiment shown in FIG. 3, is a side view of this invention. The bond magnet has the following features: on the surface of the bond magnet mount two coating layers 2 & 2-3; the first coating layer 2 is monochromatic, the material of which is printing coating either watery or oil; the second coating layer 2-3 which is colored is on the first coating layer 2-3, the material of which is a type reflex printing coating either watery or oil.

Alternative Embodiment shown in FIG. 4, is a side view of this invention. The bond magnet has the following features: the bond magnet 1 is much thicker, a monochromatic coating 2 is applied to the edge of the magnet material.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### CONCLUSIONS RAMIFICATIONS AND SCOPE

Accordingly the reader will see the simplicity and increased function and eco-friendliness of this invention. This invention provides a direct printable rubber magnet, which includes a rubber magnet layer and a coating layer. The coating layer adheres to the surface of rubber magnet layer. The coating replaces the need for adhesive on laminates. The coating replaces 50-70% of the thickness of the laminate. The coating allows for recycling easily as it does not have the cost caused by the separating laminated layers. The coating itself may be re-used in the magnet. The superficial coating layer on the rubber magnet is very thin and accounts for nothing compared to the thickness of whole magnet, and it is not necessary to separate the coating layer with magnet layer while recycling. This coating decreases the shipping weight. This coating decreases the scrap from the edges of a lamination. This invention makes the printable coating layer reach the same function as existing laminated PVC or paper. The production is much more simple than prior art laminating machines. The coating layer is covered on either one surface or both surfaces of the magnet or the edges. The coating layer could be more than one layer thick. The material of the coating layer is configured to accept either water base or oil base paint and inks or both.

The coating layer could be transparent, monochromatic, multicolor or colored. The coating layer is very thin, generally, the weight of the dry film of said coating is between 5-300 g/m2.

1. A direct printable rubber magnet, comprising a magnet layer and a coating layer. Said coating layer and said magnet affix together without an adhesive layer.

2. The direct printing rubber magnet wherein the weight of the dry film of said coating layer is between 5-300 g per square meter.

3. The direct printing rubber magnet wherein the material of the coating does not diminish the magnetic material strength more than 5% when recycled.

4. Said direct printable rubber magnet as claimed in claim 1, wherein said coating is at least on layer thick.

5. Said direct printable rubber magnet as claimed in claim 1, wherein said magnet layer is in sheet shape. Said rubber magnet is magnetically soft,

6. Said direct printable rubber magnet as claimed in claim 1, wherein it is in flat sheet shape, rolls, strips, cut shapes, blocks, discs, rings.

7. Said direct printable rubber magnet as claimed in claim 1, wherein it is in curve molded pressed contoured shapes, rolls, strips, cut shapes, blocks, discs, rings.

8. The direct printing rubber magnet as claimed in claim 1, wherein said coating layer could be transparent, monochromatic, patterned, multicolor or colored.

9. Said direct printable rubber magnet as claimed in claim 1, wherein said coating layer is at least covering 5% of any magnet surface.
